(19) United States
(12) Patent Application Publication
(10) Pub. No.: US 2007/0269693 A1
(43) Pub. Date: Nov. 22, 2007

(54) Hermetic high temperature dielectric and thermal expansion compensator

(75) Inventor: Martin Perry, Sunnyvale, CA (US)

Correspondence Address: FOLEY AND LARDNER LLP;SUITE 500, 3000 K STREET NW, WASHINGTON, DC, 20007, US

(73) Assignee: ION AMERICA CORPORATION

(21) Appl. No.: 11/436,537

(22) Filed: May 19, 2006

(51) Int. Cl. H01M 8/04; B60K 15/04

(52) U.S. Cl. 429/24; 429/34; 137/799

(57) ABSTRACT

The present invention relates to a gas delivery device or conduit for a fuel cell stack. According to an embodiment, a gas delivery device for a fuel cell system includes a hollow ceramic element comprising a dielectric material and a hollow flexible element which compensates for differences in coefficients of thermal expansion between components of the fuel cell system. According to an embodiment, a fuel cell system includes a fuel cell stack or column, a gas delivery line fluidly connected to the stack or column, and a coefficient of thermal expansion compensator/isolator located in the gas delivery line. The coefficient of thermal expansion compensator/isolator includes a hollow ceramic element comprising a dielectric material and a hollow flexible element which compensates for differences in coefficients of thermal expansion between components of the fuel cell system.

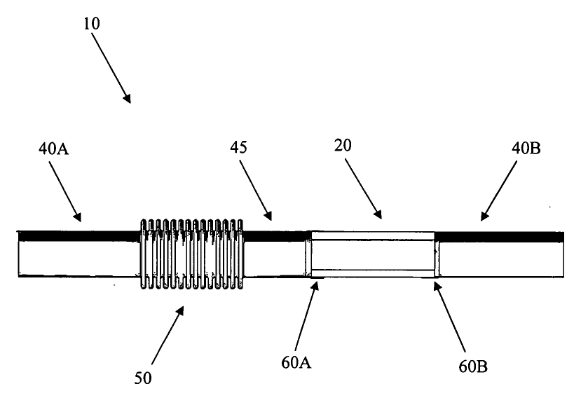

### BACKGROUND

The present invention relates to a gas delivery device or conduit for a fuel cell stack.

Fuel cells are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide reversible fuel cells, that also allow reversed operation.

In a high temperature fuel cell system such as a solid oxide fuel cell (SOFC) system, an oxidizing flow is passed through the cathode side of the fuel cell while a fuel flow is passed through the anode side of the fuel cell. The oxidizing flow is typically air, while the fuel flow is typically a hydrogen-rich gas created by reforming a hydrocarbon fuel source. The fuel cell, operating at a typical temperature between 750° C. and 950° C., enables the transport of negatively charged oxygen ions from the cathode flow stream to the anode flow stream, where the ion combines with either free hydrogen or hydrogen in a hydrocarbon molecule to form water vapor and/or with carbon monoxide to form carbon dioxide. The excess electrons from the negatively charged ion are routed back to the cathode side of the fuel cell through an electrical circuit completed between anode and cathode, resulting in an electrical current flow through the circuit.

Fuel cell stacks may be either internally or externally manifolded for fuel and air. In internally manifolded stacks, the fuel and air is distributed to each cell using risers contained within the stack. In other words, the gas flows through riser openings or holes in the supporting layer of each cell, such as the electrolyte layer, for example. In externally manifolded stacks, the stack is open on the fuel and air inlet and outlet sides, and the fuel and air are introduced and collected independently of the stack hardware. For example, the inlet and outlet fuel and air flow in separate channels between the stack and the manifold housing in which the stack is located.

### SUMMARY

According to an embodiment, a gas delivery device for a fuel cell system includes a hollow ceramic element comprising a dielectric material and a hollow flexible element which compensates for differences in coefficients of thermal expansion between components of the fuel cell system.

According to an embodiment, a fuel cell system includes a fuel cell stack or column, a gas delivery line fluidly connected to the stack or column, and a coefficient of thermal expansion compensator/isolator located in the gas delivery line, wherein the coefficient of thermal expansion compensator/isolator comprises a hollow ceramic element comprising a dielectric material and a hollow flexible element which compensates for differences in coefficients of thermal expansion between components of the fuel cell system.

According to an embodiment, a gas delivery line for a fuel cell system includes a means for electrically isolating components of a fuel cell stack or column from a balance of gas delivery plumbing for a fuel cell stack or column and a means for compensating for differences in coefficients of thermal expansion between components of the fuel cell system.

It is to be understood that both the foregoing general description and the following detailed description are exemplary and explanatory only, and are not restrictive of the invention as claimed.

### BRIEF DESCRIPTION OF THE DRAWING

These and other features, aspects, and advantages of the present invention will become apparent from the following description, appended claims, and the accompanying exemplary embodiments shown in the drawing, which is briefly described below.

The FIGURE shows a partial sectional view of a gas delivery device, with a ceramic element in partial section.

### DETAILED DESCRIPTION

Embodiments of the invention will be described below with reference to the drawing.

In the fabrication of a fuel cell stack or column, or series of fuel cell stacks or columns, the delivery of gas is an important consideration. A gas delivery line for a fuel cell stack or column contains a dielectric insert or spacer in order to isolate the balance of the delivery plumbing from the metallic components within the fuel cell stack or column, while providing a hermetic seal for the delivered gas. Additionally, the line contains a flexible element to compensate for different coefficients of thermal expansion between various plumbing components so that stresses exerted upon the fuel cell stack or column are minimized. The insert and flexible elements are hollow to form a conduit which allows gas to pass through them. The gas delivery line can be fluidly connected to a fuel cell stack or column and/or the balance of gas delivery plumbing. Fluidly connected means permitting fluid to flow from one point to another, either directly or indirectly.

According to an embodiment, the gas delivery device beneficially allows the use of metallic fuel manifold plates by electrically isolating the fuel cell stack or column from the balance of the gas delivery plumbing. The metallic manifold plates beneficially provide continuous electrical conductivity within a stack or column, thereby reducing the potential for degradation of resistance connections. Preferably, the gas delivery device provides electrical isolation of the fuel cell stack or column to a high degree by including the ceramic element.

The gas delivery device reduces the stress on tubing joints by compensating for stresses that arise from differences in coefficients of thermal expansion between various plumbing components.

The FIGURE shows a sectional view of an exemplary gas delivery device 10. According to an embodiment, the gas delivery device 10 includes a ceramic element 20, metal tubes 40A, 40B, and a flexible metal expansion element, such as a bellows 50. The ceramic element 20 is shown in cross section in the FIGURE.

The ceramic element 20 functions as a dielectric element that electrically insulates the fuel cell stack or column from the balance of the gas delivery plumbing. The ceramic element 20 is made from a ceramic material with dielectric properties such that the ceramic element 20 is electrically insulating under operating conditions. For example the ceramic element 20 is electrically insulating while gas is flowing through and contacting the ceramic element 20 and while the ceramic element 20 is exposed to operating temperatures of the fuel cell system.

According to an embodiment, the ceramic element 20 can be made of alumina or other ceramic materials possessing high dielectric strength at operating temperatures of the fuel cell system. For example, the ceramic element 20 can be made of high purity alumina.

The metal tubes 40A, 40B can be used to form metallic joints with other fuel cell system parts, such as, for example, gas delivery plumbing, the fuel cell stack or column (such as fuel inlets of one or more fuel manifold plates of the stack), and/or a fuel cell hot box. The metal tubes 40A, 40B may be joined to other fuel cell parts through mechanical seals, welds, brazes, and other joining methods known in the art.

The bellows 50 acts to compensate for differences in coefficients of thermal expansion between fuel cell components. The bellows 50 acts to minimize stresses exerted upon the fuel cell stack or column. For example the bellows 50 can act to minimize stress upon fuel cell stack or column components, such as fuel manifold plates, such as the plates described in U.S. application Ser. No. 11/276,717 filed on Mar. 10, 2006, which is incorporated by reference in its entirety.

According to an embodiment, the bellows 50 can act to minimize stresses exerted upon the fuel cell stack or column by deforming in preference to other components of the gas delivery device 10 and other fuel cell components. In this way, the bellows 50 deforms to absorb stress rather than transmitting stress to other portions of the gas delivery device 10 or other parts of a fuel cell system. The deformation of the bellows 50 can prevent the ceramic element 20 from being excessively stressed, which can cause the ceramic element 20 to crack and break. For example, the bellows 50 can deform in axial and/or radial directions in order to minimize stress upon other gas delivery device 10 components and fuel cell system parts, including the fuel cell stack or column.

According to an embodiment, the bellows 50 and/or metal tubes 40A, 40B can be made of metal alloys that can withstand the operating temperatures of the fuel cell system and have minimal reactivity with gas flowing through the gas delivery device. For example, the bellows 50 and/or metal tubes 40A, 40B can be made of stainless steels, such as 321 stainless or A286 steels, or they made of high temperature alloys, such as Ni—Cr, Ni—Cr—W, Ni—Cr—Mo, Fe—Ni, Ni—Co, Fe—Co, or Fe—Ni—Co alloys. For example, exemplary alloys include Inconel® 600 series alloys, such as 600, 601, 602, or 625 alloys; or Haynes® 200, 500, or 600 series alloys, such as 230, 556, or 617 alloys.

The materials for the ceramic element 20 and the metal tubes 40A, 40B can be selected in order to provide integrity for joint between the ceramic element 20 and the metal tubes 40A, 40B. According to an embodiment, the materials of the ceramic element 20 and the metal tubes 40A, 40B are selected so that the yield strengths of the materials for the ceramic element 20 and the metal tubes 40A, 40B are compatible with one another. For example, the metal tubes 40A, 40B can be made of 321 stainless steel and the ceramic element 20 can be made of alumina with 99.8% purity. In another example, the metal tubes 40A, 40B can be made of Inconel® alloy 600 and the ceramic element 20 can be made of alumina with 99.8% purity. In another example, the metal tubes 40A, 40B can be made of Inconel® alloy 625 and the ceramic element 20 can be made of alumina with 99.8% purity.

The joints between the ceramic element 20 and the metal tubes 40A, 40B can be mechanically designed to improved provide integrity. According to an embodiment, the metal tubes 40A, 40B can be provided with lips 60A, 60B at a distal end of the metal tubes 40A, 40B so that the lips 60A, 60B fit over the outside surface of the ceramic element 20. With this arrangement, the ceramic element 20 is seated within the lips 60A, 60B to provide further integrity to the joint between the ceramic element 20 and the metal tubes 40A, 40B. The wall thickness of the lips 60A, 60B can be, for example, 0.002″ to 0.015″, or more preferably 0.004″ to 0.012″, or more preferably 0.006″ to 0.010″. If desired, section 45 of tube 40A, which is located between ceramic element 20 and bellows 50, can have the same thickness as the lip 60A.

The wall thickness of the ceramic element 20 and the wall thickness of the metal tubes 40A, 40B can be selected to provide joint integrity, according to an embodiment. The metal tubes 40A, 40B can be thin-walled where the metal tubes 40A, 40B join the ceramic element 20. According to an embodiment, the wall thickness of the ceramic element 20 can be greater than the wall thickness of the metal tubes 40A, 40B. The wall thickness of the ceramic element 20 can be, for example, 0.020″ to 0.100″, or more preferably 0.025″ to 0.080″, or more preferably 0.030″ to 0.060″, or more preferably 0.035″ to 0.050″.

According to an embodiment, the ceramic element 20 and the metal tubes 40A, 40B can be matched by selecting a material and wall thickness for the metal tube 40A, 40B that has a compatible yield strength for matching with the wall thickness of the ceramic element 20. Preferably, the yield strength of the material for the tubes 40A, 40B is ±20% of the yield strength of the material for the ceramic element 20.

The ceramic element 20 is joined to metal tubes 40A, 40B to form a sealed joint between the ceramic element 20 and the metal tubes 40A, 40B. For example, the ceramic element 20 can be brazed to the metal tubes 40A, 40B to form a sealed joint between the ceramic element 20 and the metal tubes 40A, 40B. The braze material for joining the ceramic element 20 to the metal tubes 40A, 40B is selected for compatibility with the ceramic material of the ceramic element 20 and the metal that the tubes 40A, 40B are made from.

According to an embodiment, the ceramic element 20 can be directly joined to the bellows 50 so that an intermediate portion 45 of metal tube 40A, 40B between the bellows 50 and the ceramic element 20 is not necessary. For example, the ceramic element 20 may be brazed directly to the bellows 50. The same principles of joining the ceramic element 20 to the metal tubes 40A, 40B apply to embodiments where the ceramic element 20 is directly joined to the bellows 50.

According to an embodiment, the bellows 50 can be directly joined to other fuel cell parts without the use of a metal tube 40A, 40B. For example, the bellows 50 can be joined directly to gas delivery plumbing, the fuel cell stack or column, and/or a fuel cell hot box. The bellows 50 may be joined to other fuel cell parts through mechanical seals, welds, brazes, and other joining methods known in the art.

In the FIGURE, the fuel cell stack (not shown) would be located on the left side and the gas delivery plumbing or vessel (not shown), would be located on the right side. The bellows 50 can be arranged between the ceramic element 20 and the fuel cell stack or column, as shown in the FIGURE. According to another embodiment, the ceramic element 20 can be arranged between the bellows 50 and the fuel cell stack or column.

According to an embodiment, a second bellows 50 can be provided in the gas delivery device 10 so that a bellows is provided on each side of the ceramic element 20. Metal tubes 40A, 40B can be placed between each bellows 50 and the ceramic element 20, or the ceramic element 20 may be directly joined to one of, or each bellows 50.

According to an embodiment, the gas delivery device can be located at any point within the gas delivery plumbing of a fuel cell system. According to a further embodiment, the gas delivery device can be located at the interface of the gas delivery plumbing with the fuel cell stack so that the gas delivery device forms a joint between the fuel cell stack and the gas delivery plumbing. According to another further embodiment, the gas delivery device can be located outside of a hot box that contains the fuel cell stack, so that the gas delivery device forms a joint between the hot box and gas delivery plumbing that supplies gas to the fuel cell components inside of the hot box. According to another further embodiment, the gas delivery device can be located inside of the hot box so that the gas delivery device forms a joint with the gas delivery plumbing inside of the hot box.

The gas delivery device may be located in the fuel line which provides fuel to one or more fuel cell stacks or columns. Likewise, the gas delivery device may also be located in the fuel exhaust line, oxidizer inlet line, and/or oxidizer exhaust line. The fuel cell stacks may comprise any suitable fuel cells, such as solid oxide, molten carbonate, or other high temperature fuel cells or PEM or other low temperature fuel cells.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments.

What is claimed is:

1. A gas delivery device for a fuel cell system, comprising:
a hollow ceramic element comprising a dielectric material; and
a hollow flexible element which compensates for differences in coefficients of thermal expansion between components of the fuel cell system.

2. The gas delivery device of claim 1, further comprising a first metal tube that is arranged between the ceramic element and the flexible element.

3. The gas delivery device of claim 2, wherein the ceramic element is joined to the first metal tube.

4. The gas delivery device of claim 3, wherein the ceramic element is brazed to the first metal tube.

5. The gas delivery device of claim 2, wherein the flexible element is a bellows.

6. The gas delivery device of claim 3, wherein:
the first metal tube includes a lip at an end of the first metal tube; and
the lip is arranged around an outer surface of the ceramic element so that the ceramic element is seated within the lip.

7. The gas delivery device of claim 2, wherein the ceramic element comprises alumina and the first metal tube comprises stainless steel or a nickel-based alloy.

8. The gas delivery device of claim 2, wherein the ceramic element comprises high purity alumina and the first metal tube comprises stainless steel.

9. The gas delivery device of claim 2, wherein the ceramic element comprises high purity alumina and the first metal tube comprises a Ni—Cr—W alloy or a Ni—Fe alloy.

10. The gas delivery device of claim 1, the ceramic element is joined to the flexible element.

11. The gas delivery device of claim 10, wherein the ceramic element is brazed to the flexible element which comprises a bellows.

12. The gas delivery device of claim 2, wherein the first metal tube includes a lip at a distal end of the first metal tube.

13. The gas delivery device of claim 12, wherein a wall thickness of the lip is 0.002″ to 0.015″ and a wall thickness of the ceramic element is 0.020″ to 0.100″.

14. The gas delivery device of claim 13, wherein the wall thickness of the lip is 0.004″ to 0.012″ and the wall thickness of the ceramic element is 0.025″ to 0.080″.

15. The gas delivery device of claim 14, wherein the wall thickness of the lip is 0.006″ to 0.010″ and the wall thickness of the ceramic element is 0.035″ to 0.050″.

16. The gas delivery device of claim 2, further comprising:
a second metal tube connected to the ceramic element; and
a third metal tube connected to the flexible element;
wherein:
the ceramic element is located between the first metal tube and the second metal tube; and
the flexible element is located between the second metal tube and third metal tube.

17. The gas delivery device of claim 16, wherein:
the second metal tube is fluidly connected to a gas source;
the third tube is fluidly connected to a fuel cell stack or column; and
the flexible element comprises a bellows.

18. A fuel cell system, comprising:
a fuel cell stack or column;
a gas delivery line fluidly connected to the stack or column; and
a coefficient of thermal expansion compensator/isolator located in the gas delivery line, wherein the coefficient of thermal expansion compensator/isolator comprises:
a hollow ceramic element comprising a dielectric material; and
a hollow flexible element which compensates for differences in coefficients of thermal expansion between components of the fuel cell system.

19. A gas delivery line for a fuel cell system, comprising:
a means for electrically isolating components of a fuel cell stack or column from a balance of gas delivery plumbing for a fuel cell stack or column; and
a means for compensating for differences in coefficients of thermal expansion between components of the fuel cell system.

20. A fuel cell system, comprising:
a fuel cell stack or column;
the gas delivery line of claim 19.
